(19) United States
(12) Patent Application Publication
(10) Pub. No.: US 2016/0131166 A1
(43) Pub. Date: May 12, 2016

(54) Bicycle Mount

(71) Applicant: Brian Cox, Uwchland, PA (US)

(72) Inventor: Brian Cox, Uwchland, PA (US)

(21) Appl. No.: 14/936,799

(22) Filed: Nov. 10, 2015

Related U.S. Application Data
(60) Provisional application No. 62/078,070, filed on Nov. 11, 2014.

(51) Int. Cl. F16B 2/06; F16M 13/02; B60R 9/10

(52) U.S. Cl. CPC F16B 2/065; B60R 9/10; F16M 13/022

(57) ABSTRACT

A mount includes an upper portion having a means for releasably securing a device thereto. A lower portion has an upper half and a lower half. The upper half has a first semicircular channel and is releasably connectable to the upper portion and rotatable relative to the upper portion about a first axis. The lower half has a second semicircular channel and is releasably connectable to the upper half such that the first semicircular channel mates with the second semicircular channel forming a passage extending along a second axis perpendicular to the first axis.

### CROSS-REFERENCE TO RELATED APPLICATION

This application claims priority from U.S. Provisional Patent Application Ser. No. 62/078,070, filed on Nov. 11, 2014, Attorney Docket No. 1215-6C, which is fully incorporated herein by reference. Further, U.S. Provisional Patent Application Ser. No. 61/977,902, filed on Apr. 10, 2014, Attorney Docket No. 1215-3C, is fully incorporated herein by reference.

### FIELD OF THE INVENTION

The present invention is directed to a mount for releasably securing recreational equipment, such as, for example, a bicycle, to another vehicle, such as, for example, a boat, a car, a recreation vehicles (“RV”), or a truck.

### BACKGROUND OF THE INVENTION

It is often desired to transport athletic equipment, such as, bicycles, from one destination to another on a vehicle, such as a boat. The bicycle, however, must be securely, yet releasably, attached to the boat so that the bicycle does not fall or otherwise move while the boat is in transit.

It would be beneficial to provide a mounting device that secures a bicycle to a boat.

### BACKGROUND OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, the present invention provides a mount comprising an upper portion having a means for releasably securing a device thereto. A lower portion has an upper half and a lower half. The upper half has a first semicircular channel and is releasably connectable to the upper portion and rotatable relative to the upper portion about a first axis. The lower half has a second semicircular channel and is releasably connectable to the upper half such that the first semicircular channel mates with the second semicircular channel forming a passage extending along a second axis perpendicular to the first axis.

Further, the present invention also provides a mount comprising an upper portion having a means for releasably securing a device thereto and a lower portion having an upper half and a lower half. The upper half is rotatably releasably securable to and rotatably coupled to the upper portion along a first axis. The upper half has a first semicircular channel and the lower half has a second semicircular channel and is releasably connectable to the upper half such that the first semicircular channel mates with the second semicircular channel forming a passage extending along a second axis perpendicular to the first axis.

Additionally, the present invention provides a mount comprising a lower portion adapted to releasably mount to a cylindrical member. An upper portion is rotatably mounted to the lower portion and releasably securable to the lower portion to prevent rotation of the upper portion relative to the lower portion. The upper portion comprises a means for releasably securing the device thereto including a generally T-shaped spacer through which a mounting bar is slidably inserted. The mounting bar comprises a first end being threaded to accommodate a nut and a second end including a locking mechanism, such that a first fork gap is provided between the nut and mounting bar and a second fork gap is provided between the locking mechanism and the mounting bar.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a front elevational view of a bicycle mount according to a first exemplary embodiment of the present invention;

FIG. 2 is a top plan view of the bicycle mount of FIG. 1, taken along lines 2-2 of FIG. 1;

FIG. 3 is a bottom plan view of the bicycle mount of FIG. 1, taken along lines 3-3 of FIG. 1;

FIG. 4 is a top plan view of a lower portion of the bicycle mount of FIG. 1, taken along lines 4-4 of FIG. 1;

FIG. 5 is a side elevational view of the bicycle mount of FIG. 1, taken along lines 5-5 of FIG. 1;

FIG. 6 is a front elevational view of the bicycle mount of FIG. 1, with a top portion of the mount rotated 90° relative to a bottom portion of the mount, and with a bicycle fork releasably attached to the top portion of the mount;

FIG. 7 is a side elevational view of the bicycle mount of FIG. 1, with the top portion of the mount rotated 90° relative to the bottom portion of the mount, and with the bottom portion of the mount releasably attached to an extension;

FIG. 8 is a front elevational view of a bicycle mount according to a second exemplary embodiment of the present invention;

FIG. 8A is a sectional view of a bicycle mount according to another exemplary embodiment of the present invention;

FIG. 9A is a front elevational view of a first exemplary embodiment of a bushing for use with the bicycle mount according to the present invention;

FIG. 9B is a front elevational view of a second exemplary embodiment of a bushing for use with the bicycle mount according to the present invention; and

FIG. 9C is a front elevational view of a third exemplary embodiment of a bushing for use with the bicycle mount according to the present invention.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In the drawings, a bicycle mount for releasably securing a bicycle to a rail structure is provided. While an embodiment of the inventive mount is specifically directed toward bicycles, those skilled in the art will recognize that the inventive mount can be used to releasably secure other devices as well. Further, the rail structure to which the inventive mount can be secured may be a horizontally mounted rail on a vehicle, such as, for example, a boat, a car, a recreation vehicle (“RV”), a truck, or other suitable vehicle, although those skilled in the art will recognize that the rail structure can be horizontally mounted to other structures or that the rail structure can be other than horizontally mounted, such as, for example, vertically mounted to a structure.

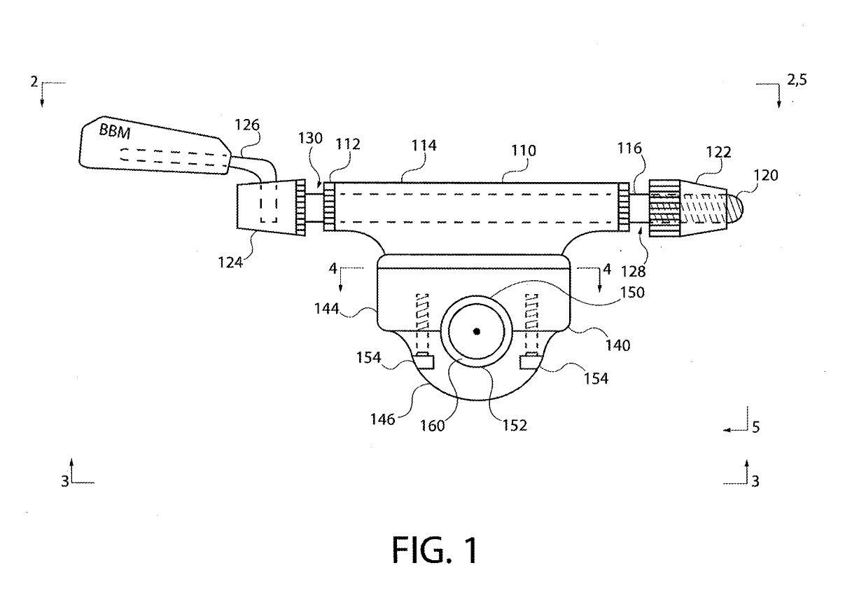

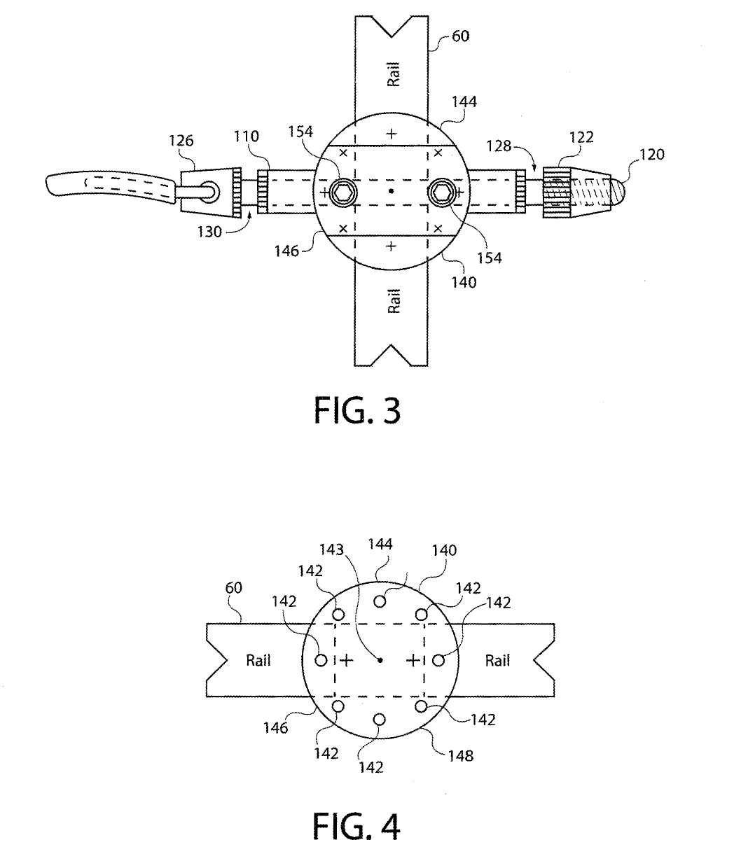

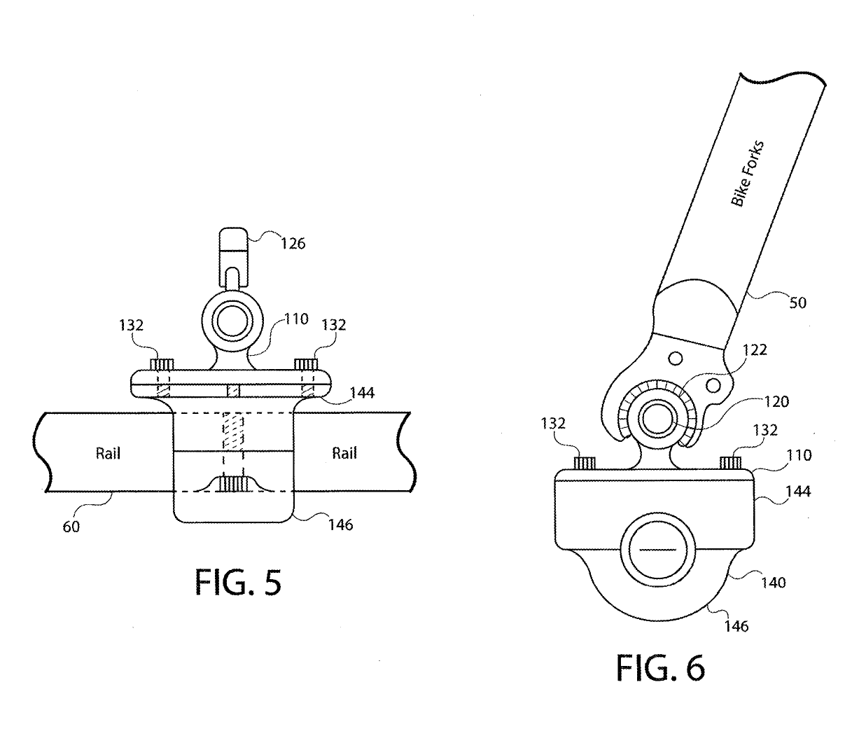

Referring to FIGS. 1-5, a first exemplary embodiment of a bicycle mount 100 according to the present invention is shown. Mount 100 has an upper portion 110 that is rotatably coupled to a lower portion 140. Upper portion 110 can be used to releasably secure bicycle forks 50 thereto, as shown in FIG. 6, while lower portion 140 can be used to releasably secure mount 100 to a rail 60, as shown in FIG. 5.

Upper portion 110 includes a fork grip assembly 112 that releasably secures the bicycle forks 50 to mount 100. Fork grip assembly 112 includes a central, generally T-shaped spacer 114 through which a mounting bar 116 is slidably inserted. A first end 120 of mounting bar 116 is threaded to accommodate a nut 122. A second end 124 of mounting bar 116 includes a locking mechanism 126. A first fork gap 128 is provided between nut 122 and mounting bar 116 and a second fork gap 130 is provided between locking mechanism 126 and mounting bar 116 to allow bicycle forks 50 (shown FIG. 6) to be inserted therein. Nut 122 can be tightened onto mounting bar 116 and locking mechanism 126 can be engaged to secure bicycle forks 50 to upper portion 110. Fork grip assembly 112 can be a commercially available grip assembly, as is well known to those skilled in the art.

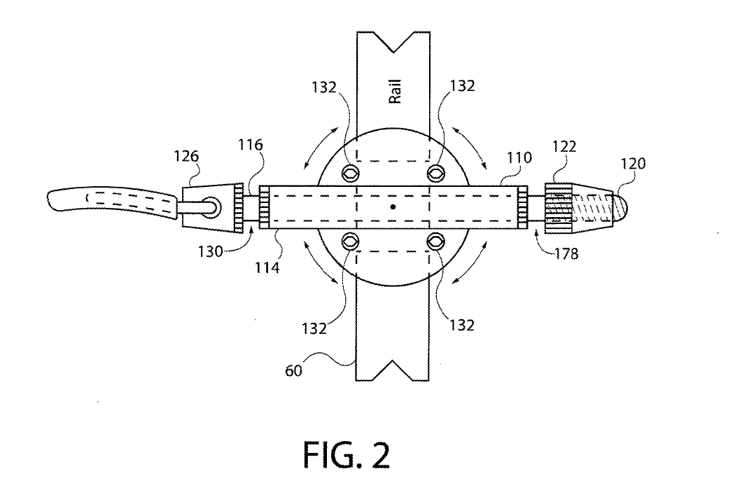

Referring to FIG. 2, upper portion 110 includes a plurality of bolts 132 extending therethrough, and into lower portion 140 to secure upper portion 110 to lower portion 140. As shown in FIG. 4, lower portion 140 includes a plurality of threaded holes 142 extending in a circular bolt pattern such that bolts 132 can be threaded thereinto to releasably secure upper portion 110 to lower portion 140 in a desired relative arrangement.

FIG. 2 shows four bolts 132 are arranged at 90° increments relative to a central point, while FIG. 4 shows eight threaded holes 142 arranged at 45° increments about a central axis 143 that extends perpendicularly from the plane of FIG. 4, allowing upper portion 110 to be rotated relative to lower portion 140 at 45° increments. Those skilled in the art, however, will recognize that other numbers and patterns of bolts 130, and other numbers and patterns of threaded holes 142 can be provided to allow upper portion 110 to be rotated relative to lower portion 140 about central axis 143 at different desired increments.

Lower portion 140 includes an upper rail half 144 and lower rail half 146 that can be releasably secured to each other to secure mount 100 to rail 60. Upper rail half 144 includes a flat, planar surface 148, shown in FIG. 4, that mates with upper portion 110. Upper rail half 144 also includes a generally semicircular channel 150. Lower rail half 146 also includes a generally semicircular channel 152 that mates with channel 150 when upper rail half 144 is secured to lower rail half 146. A plurality of bolts 154 releasably secure upper rail half 144 to lower rail half 146.

A bushing 160 fits within the circular channel formed by channel 150 and channel 152 when upper rail half 144 is secured to lower rail half 146. Bushing 160 has an outer diameter sized to engage channel 150 and channel 152 and an inner diameter sized to engage rail 60. Bushing 160 can be constructed from a low friction material, such as, for example, nylon. Bushing 160 can be a single piece, as shown in FIG. 1, and slid along rail 60 prior to installing mount 100 to rail 60. Alternatively, Bushing 160 can be multiple pieces, such that an upper portion of bushing 160 is retained within channel 150 and a lower portion of bushing 160 is retained within channel 152.

In use, bushing 160 can be inserted over one end of rail 60 and slid along rail 62, a desired location. Lower rail half 146 is applied to bushing 160 such that bushing 160 fits into channel 152. Upper rail half 144 is applied to bushing 160 such that bushing 160 fits into channel 150. Upper rail half 144 is then secured to lower rail half 146 using bolts 154.

If upper portion 110 is not aligned in a desired direction relative to rail 60, bolts 132 can be removed from upper portion 110 and upper portion 110 can then be rotated relative to lower portion 140 until upper portion 110 is aligned in a desired direction relative to rail 60. Bolts 132 can then be inserted through upper portion 110 and into threaded holes 142 to secure upper portion 110 to lower portion 140.

Bike forks 50 can then be inserted into first fork gap 128 and second fork gap 130 and releasably secured to upper portion 110 by engaging locking mechanism 126. Bike forks 50 can be removed from mount 100 by releasing locking mechanism 126 and removing bike forks 50 from first fork gap 128 and second fork gap 130.

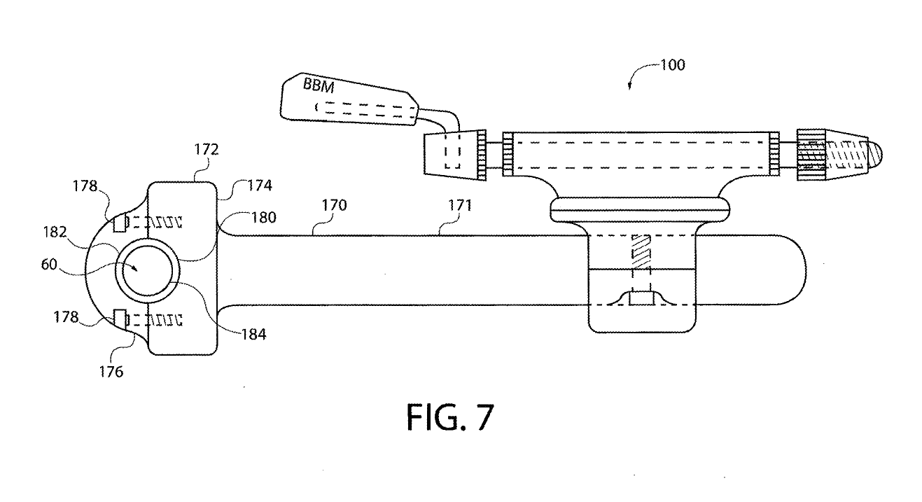

Optionally, if rail 60 is not located in a suitable place to attach mount 100 and/or the bike that is to be secured by mount 100, as shown FIG. 7, an extension 170 can be used with mount 100. Extension 170 has an elongated portion 171 with an outer diameter sized to fit interior diameter of bushing 160. Extension 170 also has a rail gripping portion 172 at one end thereof. Rail gripping portion 172 includes an attached portion 174, and a detachable portion 176 that is releasably attachable to attached portion 174, such as by bolts 178. Similar to lower portion 140, rail gripping portion 172 includes a generally semicircular channel 180 in attached portion 174 and a generally semicircular channel 182 in detachable portion 176. A bushing 184 that can be the same size and dimensions of bushing 160, can be inserted into channels 180, 182 around rail 60.

Extension 170 can be mounted such that elongated portion 171 extends horizontally, as shown FIG. 7, or, alternatively, extension 170 can be rotated about rail 60 such that elongated portion 171 extends along any angle relative to the horizontal.

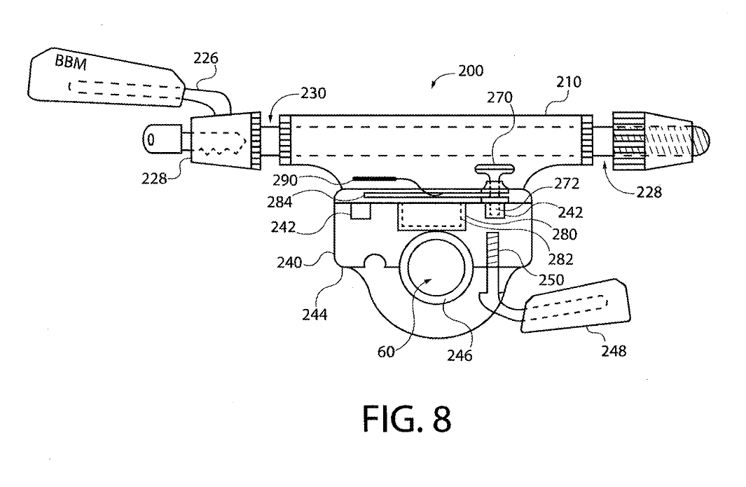

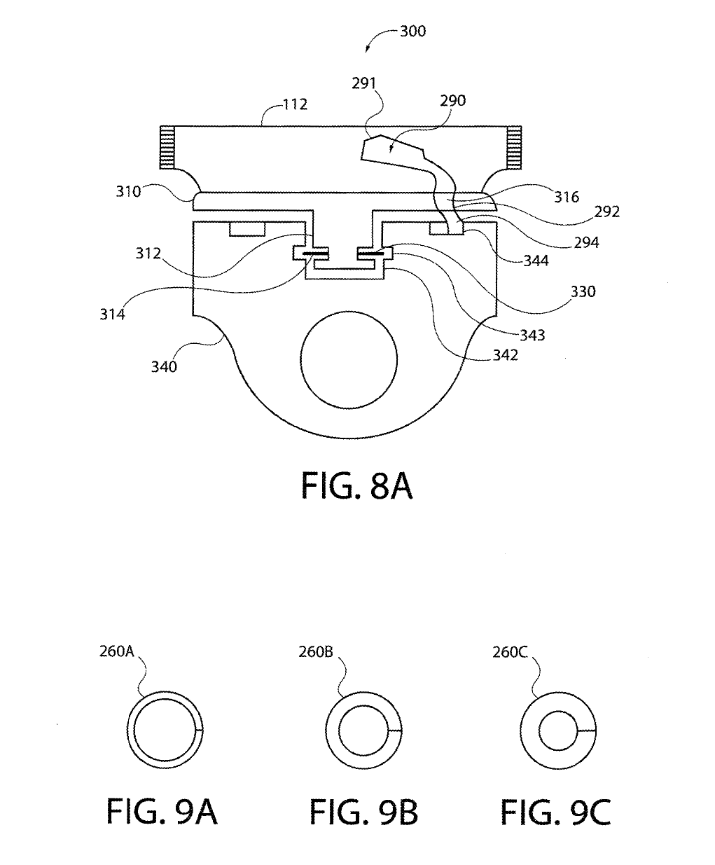

An alternative exemplary embodiment of a mount 200 according to the present invention is shown in FIG. 8. Mount 200 provides several alternative features, any or all of which can be incorporated into mount 200. A keyed lock 228, mounted on locking mechanism 226, can be used to prevent locking mechanism 226 from being undone and removing bike forks 50 (bike forks 50 are shown in FIG. 6). To further secure bike forks 52, mount 200 can include knurled or otherwise textured surfaces on either side of fork gaps 228, 230.

Further, instead of bolts 132 to secure upper portion 210 to lower portion 240, a spring loaded handle 270 operates a pin 272 that is sized to fit into one of a plurality of openings 242 provided in lower portion 240. Openings 242 can have the same bolt circle pattern as openings 142 in mount 100 or, alternatively, openings 242 can have a different bowl circle pattern.

Upper portion 210 includes a pressed pin 280 extending downwardly from under portion 210 and into a mating cavity 282 in the top of lower portion 240. An annular bearing surface 284 is located between upper portion 210 and lower portion 240, with pin 280 extending through an opening in bearing surface 284 such that upper portion 210 is rotatably secured to lower portion 240 and rotatable relative to lower portion 240 about a 360° arc. In an exemplary embodiment, the bearing surface 284 is constructed from a low friction material, such as, for example, nylon.

Handle 270 can be pulled upward to pull pin 272 out of its respective opening 242. While pin 272 is out of opening 242, upper portion 210 can be rotated on bearing surface 284, about pressed pin 280, relative to lower portion 240 until upper portion 210 is in a desired position relative to lower portion 240. Handle 270 is then released and pin 272 is biased against lower portion 240. If pin 272 is not aligned with an opening 242, upper portion 210 can be rotated clockwise or counterclockwise until pin 272 is aligned with an adjacent opening 242, at which point pin 272 is biased into opening 242, securing the rotation of upper portion 210 with respect to lower portion 240.

A brake 290 is shown in more detail in mount 300 as shown in FIG. 8A. Brake 290 is mounted on an upper portion 310 and has a handle 291 extending upwardly therefrom. A tubular portion 292 extends downwardly from handle portion 291 and through an opening 318 located off-center through lower portion 310. An engagement portion 294 extends downward eccentrically from tubular portion 292.

Upper portion 310 also includes a central pin 312 that provides a rotational connection with a lower portion 340. Lower portion 340 includes a co-axial cylindrical opening 342 into which central pin 312 is inserted. Central pin 312 includes an annular groove 314 that extends coplanar with an annular groove 343 in the vertical wall of opening 342. An annular flex ring 330 fits within annular groove 314. When central pin 312 is inserted into central opening 324, flex ring 330 snaps into groove 343, rotatably securing top portion 310 to bottom portion 340.

Bottom portion 340 also includes an annular groove 344 extending along a top portion thereof such that engagement portion 294 of brake 290 extends into groove 344. When handle 291 is rotated about tubular portion 292, engagement portion 294 engages a sidewall of groove 344, frictionally engaging engagement portion 294 with lower portion 340 and preventing upper portion 310 from rotating with respect to lower portion 340, thereby allowing infinite rotation and locking of upper portion 310 with respect to lower portion 340 such that fork grip assembly 112 can be rotated and locked in any position relative to lower portion 340.

Referring back to FIG. 8, instead of lower portion 240 having an upper rail half 144 and a separate lower rail half 146, as shown in mount 100 above, lower portion 240 includes an upper rail half 244 and a lower rail half 246 hingedly coupled to upper rail half 244, such as, for example, by a puzzle fit hinge. Such a hinge allows lower rail half 246 to pivot away from upper rail half 244, allowing rail 60 to fit into a generally cylindrical passage 246 formed by upper rail half 244 and lower rail half 246, wherein a threaded locking lever 248 extends through lower rail half 246, and into upper rail half 244 such that a rotation of locking lever 248 engages a threaded opening 250 in upper rail half 246, thereby releasably securing lower rail half 246 to upper rail half 244.

Additionally, instead of a single piece bushing 160, as described above with respect to mount 100 or, alternatively a two piece bushing, split bushings 260A, 260B, 260C, shown FIGS. 9A-9C, respectively, can be provided for use with mount 200. Each of split bushings 260A, 260B, 260C has an outer diameter sized to fit within cylindrical passage 246. Each of split bushings 260A, 260B, 260C, however, has a different inner diameter to allow for use with different sized rails 60. For example, bushing 260A can have an inner diameter sized to accommodate rail 60 having an outer diameter of 1 inch; bushing 260B can have an inner diameter sized to accommodate rail 60 having an outer diameter of three-quarter inch; and bushing 260C can have an inner diameter sized to accommodate rail 60 having an outer diameter of ½ inch.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A mount comprising:
an upper portion having a means for releasably securing a device thereto; and
a lower portion having an upper half and a lower half, the upper half having a first semicircular channel and being releasably connectable to the upper portion and rotatable relative to the upper portion about a first axis, the lower half having a second semicircular channel and being releasably connectable to the upper half such that the first semicircular channel mates with the second semicircular channel forming a passage extending along a second axis perpendicular to the first axis.

2. The mount according to claim 1, wherein the lower half is hingedly connected to the upper half.

3. The mount according to claim 2, further comprising a securing mechanism adapted to rotatably secure the lower half to the upper half.

4. The mount according to claim 1, further comprising a bushing disposed in the first and second semicircular channels.

5. The mount according claim 4, wherein the bushing comprises one bushing selected from a plurality of bushings provided with the mount.

6. The mount according to claim 1, further comprising a means for preventing rotation of the upper portion relative to the lower portion.

7. A mount comprising:
an upper portion having a means for releasably securing a device thereto; and
a lower portion having an upper half and a lower half, the upper half being rotatably releasably securable to and rotatably coupled to the upper portion along a first axis, the upper half having a first semicircular channel and the lower half having a second semicircular channel and being releasably connectable to the upper half such that the first semicircular channel mates with the second semicircular channel forming a passage extending along a second axis perpendicular to the first axis.

8. The mount according claim to 7, further comprising a low friction bearing surface disposed between the upper portion and a lower portion.

9. The mount according to claim 8, wherein the low friction bearing surface comprises an annular ring.

10. The mount according to claim 7, wherein the upper portion has a central pin extending downwardly therefrom, and wherein the lower portion has an opening such that the central pin is rotatably inserted into the opening.

11. The mount according to claim 10, further comprising a ring having an inner diameter inserted into the central pin and an outer diameter inserted into the upper portion through the opening.

12. The mount according to claim 7, wherein the lower portion has an annular groove extending along a top portion thereof and wherein the upper portion has a handle extending upwardly therefrom and an engagement portion extending into the groove, such that the handle is movable to engage a sidewall of the groove, thereby frictionally engaging the engagement portion with the lower portion and preventing the upper portion from rotating with respect to the lower portion.

13. The mount according to claim 7, further comprising an extension having a free end insertable into the passage and a connecting end, distal from the free end, having means for rotatably connecting the extension to a support.

14. The mount according to claim 7, wherein the means for releasably securing the device thereto comprises a generally T-shaped spacer through which a mounting bar is slidably inserted.

15. The mount according to claim 14, wherein the mounting bar comprises a first end being threaded to accommodate a nut and a second end including a locking mechanism, such that a first fork gap is provided between the nut and mounting bar and a second fork gap is provided between the locking mechanism and the mounting bar.

16. A mount comprising:
a lower portion adapted to releasably mount to a cylindrical member; and
an upper portion rotatably mounted to the lower portion and releasably securable to the lower portion to prevent rotation of the upper portion relative to the lower portion, the upper portion comprising a means for releasably securing the device thereto comprises a generally T-shaped spacer through which a mounting bar is slidably inserted, wherein the mounting bar comprises a first end being threaded to accommodate a nut and a second end including a locking mechanism, such that a first fork gap is provided between the nut and mounting bar and a second fork gap is provided between the locking mechanism and the mounting bar.

17. The mount according to claim 16, wherein the lower portion comprises an upper half and a lower half.

18. The mount according to claim 17, wherein the lower half is rotatably connected to the upper half.

19. The mount according to claim 18, wherein the lower half comprises a locking lever insertable into the upper half to releasably secure the lower half to the upper half.

20. The mount according to claim 17, wherein the upper half comprises a locking lever releasably engageable with the lower half to secure the upper half to the lower half.
